(19) United States
(12) Patent Application Publication
(10) Pub. No.: US 2025/0244620 A1
(43) Pub. Date: Jul. 31, 2025

(54) Interconnections for Tunable Lens Systems

(71) Applicant: Apple Inc., Cupertino, CA (US)

(72) Inventors: Gregory L. Tice, Cupertino, CA (US); Patrick R. Gill, Victoria (CA); Yashar Abdollahian, San Jose, CA (US); Jeffrey J. Czerniak, San Jose, CA (US); Yu Horie, San Jose, CA (US); Andrew Sterian, Cupertino, CA (US)

(21) Appl. No.: 18/975,006

(22) Filed: Dec. 10, 2024

Related U.S. Application Data
(60) Provisional application No. 63/625,760, filed on Jan. 26, 2024.

(51) Int. Cl. G02F 1/1333; G02C 7/08; G02F 1/1339

(52) U.S. Cl. CPC G02F 1/133302; G02C 7/083; G02F 1/1339

(57) ABSTRACT

Eyeglasses may include left and right adjustable lenses. Each adjustable lens may include a stack of liquid crystal cells that are interconnected using vertical interconnect structures such as through-substrate-vias, conductive beads in a liquid crystal sealant, anisotropic conductive adhesive, conductive epoxy, diffusion bonds, eutectic bonds, and/or other suitable interconnect structures. Each liquid crystal cell in the stack may include liquid crystal material sandwiched between first and second substrates. A sealant may surround the liquid crystal material and may include conductive beads that form intra-cell connections between the first and second substrates of that liquid crystal cell. Through-substrate-vias may be formed in the substrate and may be coupled to the conductive beads in the sealant. Anisotropic adhesive, conductive epoxy, or other conductive material may be located between the liquid crystal cells and may be used to form inter-cell connections in the stack.

This application claims the benefit of U.S. provisional patent application No. 63/625,760, filed Jan. 26, 2024, which is hereby incorporated by reference herein in its entirety.

### BACKGROUND

This relates generally to optical systems and, more particularly, to devices with tunable lenses.

Eyewear may include optical systems such as lenses. For example, eyewear such as a pair of glasses may include lenses that allow users to view the surrounding environment.

It can be challenging to design devices such as these. If care is not taken, the optical systems in these devices may not be able to accommodate different eye prescriptions and may not perform satisfactorily.

### SUMMARY

Eyeglasses may be worn by a user and may include one or more adjustable lenses each aligned with a respective one of the user's eyes. For example, a first adjustable lens may align with the user's left eye and a second adjustable lens may align with the user's right eye. Each of the first and second adjustable lenses may include a stack of liquid crystal cells or other voltage-modulated optical material. Control circuitry may apply control signals to an array of electrodes in each liquid crystal cell to adjust a phase profile of the liquid crystal material.

The stack of liquid crystal cells may be interconnected using vertical interconnect structures such as through-substrate-vias, conductive beads in a liquid crystal sealant, anisotropic conductive adhesive, conductive epoxy, diffusion bonds, eutectic bonds, and/or other suitable interconnect structures. Each liquid crystal cell in the stack may include liquid crystal material sandwiched between first and second substrates. A printed circuit may be coupled to one or more substrates in the stack. A sealant may surround the liquid crystal material and may include conductive beads that form intra-cell connections between the first and second substrates of that liquid crystal cell. The conductive beads may be electrically insulated from one another to form multiple independent signal paths between the first and second substrates. Through-substrate-vias may be formed in the substrate and may be coupled to the conductive beads in the sealant. Anisotropic adhesive or other conductive material may be located between the liquid crystal cells and may be used to form inter-cell connections in the stack.

Liquid crystal materials are herein used by way of an example of an electrically modulated optical material. Other electrically modulated optical materials can be used in place of the liquid crystals described herein.

### BRIEF DESCRIPTION OF THE DRAWINGS

FIG. 1 is a diagram of illustrative system that includes eyeglasses with adjustable lenses in accordance with an embodiment.

FIG. 2 is a side view of an illustrative liquid crystal cell that may be used to form an adjustable lens in accordance with an embodiment.

FIG. 3 is a side view of an illustrative liquid crystal module having first and second liquid crystal layers with antiparallel liquid crystal alignment orientations in accordance with an embodiment.

FIGS. 4 and 5 are graphs showing how an adjustable lens may have a refractive index that varies as a function of position to produce a desired lens profile in accordance with some embodiments.

FIG. 6 is a top view of an illustrative adjustable lens having arrays of electrodes that extend along first and second different directions in accordance with an embodiment.

FIG. 7 is a top view of an illustrative adjustable lens having arrays of electrodes that extend along first, second, and third different directions in accordance with an embodiment.

FIG. 8 is an exploded perspective view of an illustrative adjustable lens having first, second, and third liquid crystal cells with different orientations of electrodes in accordance with an embodiment.

FIG. 9 is an exploded perspective view of an illustrative adjustable lens having first, second, and third liquid crystal modules with different orientations of electrodes in accordance with an embodiment.

FIG. 10 is a perspective view of an illustrative liquid crystal cell with a passive matrix electrode array in accordance with an embodiment.

FIG. 11 is a diagram showing illustrative stacked liquid crystal cells having passive matrix electrode arrays with different electrode orientations in accordance with an embodiment.

FIG. 12 is a perspective view of a foveated adjustable lens system in accordance with an embodiment.

FIG. 13 is a top view of an illustrative adjustable lens system having a subset of electrodes that are driven to produce a lens patch of variable optical power that aligns with a user's gaze in accordance with an embodiment.

FIG. 14 is a side view of an illustrative adjustable lens having a stack of liquid crystal cells that are interconnected using conductive beads in a sealant, through-substrate-vias, and conductive adhesive between the vias in accordance with an embodiment.

FIG. 15 is a side view of an illustrative adjustable lens having a stack of liquid crystal cells that are interconnected using conductive beads in a sealant, through-substrate-vias, and conductive material between the vias in accordance with an embodiment.

FIG. 16 is a side view of an illustrative adjustable lens having a stack of liquid crystal cells that share substrates and that are interconnected using through-substrate-vias and conductive material between the vias in accordance with an embodiment.

FIG. 17 is a side view of an illustrative adjustable lens having a stack of liquid crystal cells that share substrates and that are interconnected using through-substrate-vias and conductive beads in a sealant in accordance with an embodiment.

### DETAILED DESCRIPTION

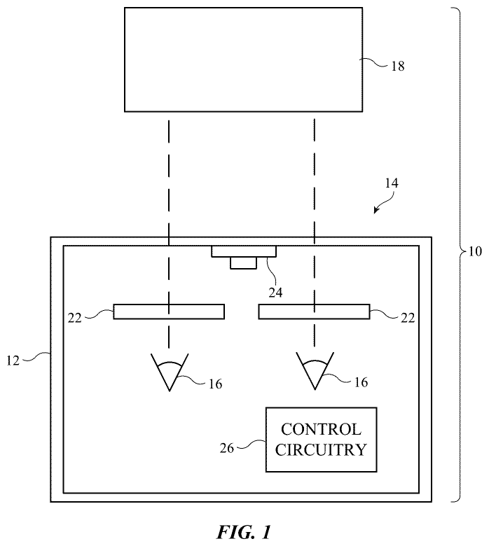

An illustrative system having a device with one or more electrically adjustable optical elements is shown in FIG. 1. System 10 may include a head-mounted device such as eyeglasses 14 (sometimes referred to as glasses 14). Glasses 14 may include one or more optical systems such as adjustable lens components 22 mounted in a support structure such as support structure 12. Structure 12 may have the shape of a pair of eyeglasses (e.g., with independent supporting frames or a single common support frame), may have the shape of goggles, may form a housing having a helmet shape, or may have other configurations to help in mounting and securing the components of glasses 14 on the head of a user.

Adjustable lens components 22 may form lenses that allow a viewer (e.g., a viewer having eyes 16) to view external objects such as object 18 in the surrounding environment. Glasses 14 may include one or more adjustable lens components 22, each aligned with a respective one of a user's eyes 16. As an example, lens components 22 may include a left lens 22 aligned with a viewer's left eye and may include a right lens 22 aligned with a viewer's right eye. This is, however, merely illustrative. If desired, glasses 14 may include adjustable lens components 22 for a single eye.

Adjustable lenses 22 may be corrective lenses that correct for vision defects. For example, eyes 16 may have vision defects such as myopia, hyperopia, presbyopia, astigmatism, higher-order aberrations, and/or other vision defects. Corrective lenses such as lenses 22 may be configured to correct for these vision defects. Lenses 22 may be adjustable to accommodate users with different vision defects and/or to accommodate different focal ranges. For example, lenses 22 may have a first set of optical characteristics for a first user having a first prescription and a second set of optical characteristics for a second user having a second prescription. Glasses 14 may be used purely for vision correction (e.g., glasses 14 may be a pair of spectacles) or glasses 14 may include displays that display virtual reality or augmented reality content (e.g., glasses 14 may be a head-mounted display). In virtual reality or augmented reality systems, adjustable lens components 22 may be used to move content between focal planes from the perspective of the user. Arrangements in which glasses 14 are spectacles that do not include displays are sometimes described herein as an illustrative example.

Glasses 14 may include control circuitry 26. Control circuitry 26 may include processing circuitry such as microprocessors, digital signal processors, microcontrollers, baseband processors, image processors, application-specific integrated circuits with processing circuitry, and/or other processing circuitry and may include random-access memory, read-only memory, flash storage, hard disk storage, and/or other storage (e.g., a non-transitory storage media for storing computer instructions for software that runs on control circuitry 26).

If desired, control circuitry 26 may include one or more energy storage devices such as one or more batteries and capacitors. Energy storage devices in eyeglasses 14 may be charged via a wired connection or, if desired, eyeglasses 14 may charge energy storage devices using wirelessly received power (e.g., inductive wireless power transfer, using capacitive wireless power transfer, and/or other wireless power transfer configurations).

Glasses 14 may include input-output circuitry such as eye state sensors, range finders disposed to measure the distance to external object 18, touch sensors, buttons, microphones to gather voice input and other input, sensors, and other devices that gather input (e.g., user input from viewer 16) and may include light-emitting diodes, displays, speakers, and other devices for providing output (e.g., output for viewer 16). Glasses 14 may, if desired, include wireless circuitry and/or other circuitry to support communications with a computer or other external equipment. If desired, a sensor system such as sensor system 24 may be used to gather input during use of glasses 14. Sensor system 24 may include an accelerometer, compass, an ambient light sensor or other light detector, a proximity sensor, a scanning laser system, and other sensors for gathering input during use of glasses 14. Sensor system 24 may be used to track a user's eyes 16. For example, sensor system 24 may include one or more digital image sensors, lidar (light detection and ranging) sensors, ultrasound sensors, or other suitable sensors for tracking the location of a user's eyes. As an example, sensor system 24 may be used by control circuitry 26 to gather images of the pupils and other portions of the eyes of the viewer. The locations of the viewer's pupils and the locations of the viewer's pupils relative to specular glints from light sources with known positions or the rest of the viewer's eyes may be used to determine the locations of the centers of the viewer's eyes (i.e., the centers of the user's pupils) and the direction of view (gaze direction) of the viewer's eyes. In some arrangements, sensor system 24 may include a wavefront sensor that measures the aberrations of a user's eyes. Control circuitry 26 may then adjust the optical properties of lens component 22 to correct the user-specific aberrations detected by the wavefront sensor.

Control circuitry 26 may also control the operation of optical elements such as adjustable lens components 22. Adjustable lens components 22, which may sometimes be referred to as adjustable lenses, adjustable lens systems, adjustable optical systems, adjustable lens devices, tunable lenses, etc., fluid-filled variable lenses, and/or may contain electrically adjustable material such as liquid crystal material, volume Bragg gratings, or other electrically modulated material that may be adjusted to produce customized lenses. Each of components 22 may contain an array of electrodes that apply electric fields to portions of a layer of liquid crystal material or other voltage-modulated optical material with an electrically adjustable index of refraction (sometimes referred to as an adjustable lens power or adjustable phase profile). By adjusting the voltages of signals applied to the electrodes, the index of refraction profile of components 22 may be dynamically adjusted. This allows the size, shape, and location of the lenses formed within components 22 to be adjusted.

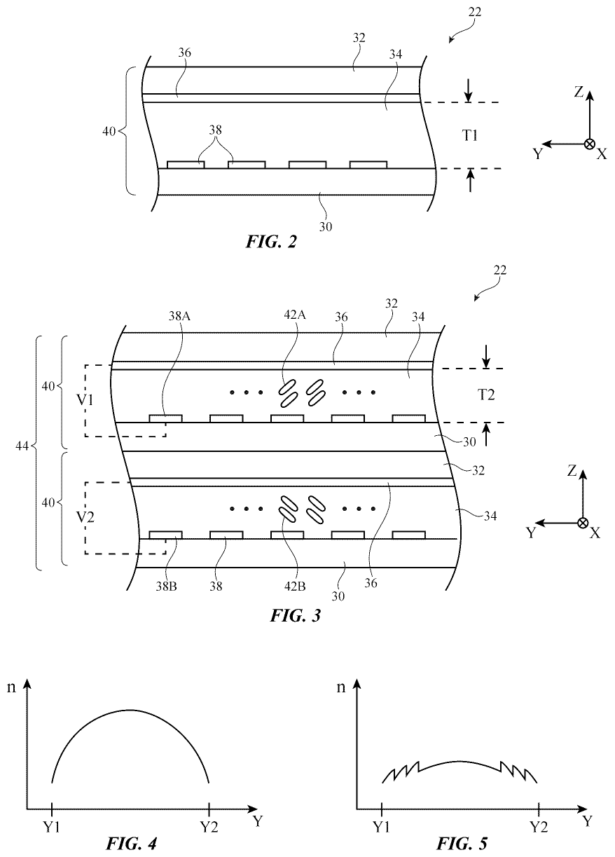

A side view of an illustrative adjustable lens component is shown in FIG. 2. As shown in FIG. 2, component 22 may include liquid crystal cell 40. Liquid crystal cell 40 may have a layer of voltage-modulated optical material such as liquid crystal layer 34. Liquid crystal layer 34 may be interposed between transparent substrates such as upper substrate 32 and lower substrate 30. Substrates 32 and 30 may be formed from clear glass, sapphire or other transparent crystalline material, cellulose triacetate, transparent plastic, or other transparent layers. Component 22 may have a pattern of electrodes that can be supplied with signals from control circuitry 26 to produce desired voltages on component 22. In the example of FIG. 2, these electrodes include elongated electrodes (e.g., strip-shaped electrodes) such as electrodes 38 on substrate 30 that run along the X dimension and a common electrode such as common electrode 36 on substrate 32 (e.g., a blanket layer of conductive material on substrate 32). Electrodes 36 and 38 may be formed from transparent conductive material such as indium tin oxide, conductive polymers such as poly(3,4-ethylenedioxythiophene) polystyrene sulfonate (PEDOT:PPS), or other transparent electrode structures and may be located on outer and/or inner surfaces of substrates 32 and 30.

At each location of electrode strips 38 in component 22, a desired voltage may be applied across liquid crystal layer 34 by supplying a first voltage to electrode 38 and a second voltage (e.g., a ground voltage) to common electrode 36. The liquid crystal between the two electrodes will receive an applied electric field with a magnitude that is proportional to the difference between the first and second voltages on the electrodes. By controlling the voltages on electrodes 38 and common electrode 36, the index of refraction of liquid crystal layer 34 of component 22 can be dynamically adjusted to produce customized lenses.

In the example of FIG. 2, strip-shaped electrodes 38 (sometimes referred to as finger electrodes, patterned electrodes, etc.) extend parallel to the X-axis. This allows the index-of-refraction profile (sometimes referred to as the phase profile) of liquid crystal cell 40 to be modulated in the Y-dimension by applying the desired voltages to each finger electrode 38.

When an electric field is applied to the liquid crystals of layer 34, the liquid crystals change orientation. The speed at which a given liquid crystal material can be reoriented is limited by factors such as the thickness of layer 34 (e.g., thickness T1 of FIG. 2, sometimes referred to as the cell gap). To increase the tuning speed of liquid crystal layer 34 while still achieving a suitable tuning range, adjustable lens component 22 may include two or more liquid crystal cells 40 stacked on top of one another. This type of arrangement is illustrated in FIG. 3.

As shown in FIG. 3, adjustable lens component 22 may include liquid crystal module 44. Liquid crystal module 44 may include two or more liquid crystal cells 40. Each liquid crystal cell may include liquid crystal layer 34 interposed between upper substrate 32 and lower substrate 30. Finger electrodes 38 may be formed on each lower substrate 30 and may extend parallel to the X-axis. Common electrode 36 may be formed on each upper substrate 32. If desired, common voltage electrode 36 may be formed on lower substrate 30 and finger electrodes 38 may be formed on upper substrate 32. The example of FIGS. 2 and 3 is merely illustrative.

The cell gap of each liquid crystal cell 40 in module 44 may be less than that of liquid crystal cell 40 of FIG. 2. For example, liquid crystal layers 34 of module 44 in FIG. 3 may each have a thickness T2, which is less than thickness T1 of liquid crystal layer 34 in cell 40 of FIG. 2. The reduced cell gap increases the tuning speed of liquid crystal layers 34 while still maintaining satisfactory tuning range (sometimes referred to as lens power range).

If desired, the liquid crystal alignment orientation (sometimes referred to as a rubbing direction) of liquid crystal cells 40 in module 44 may be antiparallel. In particular, liquid crystal molecules 42A of upper liquid crystal cell 40 may have a first liquid crystal alignment orientation, and liquid crystal molecules 42B of lower liquid crystal cell 40 may have a second liquid crystal alignment orientation that is antiparallel to the first liquid crystal alignment orientation. This type of arrangement may help reduce the angle dependency of phase retardation in module 44.

At each location of finger electrode 38 in component 22, a desired voltage may be applied across each liquid crystal layer 34 by supplying a first voltage to finger electrode 38 and a second voltage (e.g., a ground voltage) to common electrode 36. The liquid crystal between the two electrodes will receive an applied electric field with a magnitude that is proportional to the difference between the first and second voltages on the electrodes. By controlling the voltages on electrodes 38 and common electrode 36, the index of refraction of each liquid crystal layer 34 of component 22 can be dynamically adjusted to produce customized lenses. Because finger electrodes 38 extend along the X-dimension, the phase profile of each liquid crystal cell 40 may be modulated in the Y-dimension by applying the desired voltages to each finger electrode 38.

Overlapping portions of the two liquid crystal layers 34 in module 44 may be controlled using the same or different voltages to achieve the desired index of refraction at that portion of module 44. For example, finger electrode 38A of upper liquid crystal cell 40 in module 44 may overlap finger electrode 38B of lower liquid crystal cell 40 in module 44. A first voltage V1 may be applied across a portion of upper liquid crystal layer 34 overlapping finger electrode 38A, and a second voltage V2 may be applied across a portion of lower liquid crystal layer 34 overlapping finger electrode 38B. Voltages V1 and V2 may be different or may be the same. Control circuitry 26 may determine the ratio of V1 to V2 based on the desired index of refraction at that portion of the liquid crystal module 44 and based on the disposition of the user's eyes 16.

FIGS. 4 and 5 show examples of illustrative index-of-refraction profiles that may be generated by adjustable lens component 22 of FIG. 2 and/or by adjustable lens component 22 of FIG. 3. In the example of FIG. 4, refractive index n has been varied continuously between peripheral lens edges Y1 and Y2. In the example of FIG. 5, refractive index n has been varied discontinuously to produce an index-of-refraction profile appropriate for forming a Fresnel lens. These examples are merely illustrative. If desired, other suitable index-of-refraction profiles may be used using adjustable lens components of the type shown in FIGS. 2 and 3.

In the examples of FIGS. 2 and 3, each liquid crystal cell 40 in adjustable lens component 22 includes electrodes that extend in one direction (e.g., the X-dimension of FIGS. 2 and 3), allowing that liquid crystal cell 40 to modulate the phase profile of liquid crystal material 34 along one direction (e.g., the Y-dimension of FIGS. 2 and 3). If desired, adjustable lens component 22 may include multiple stacked liquid crystal cells 40 with electrodes that extend in multiple different directions, thus allowing adjustable lens component 22 to modulate the phase profile of component 22 along multiple different directions.

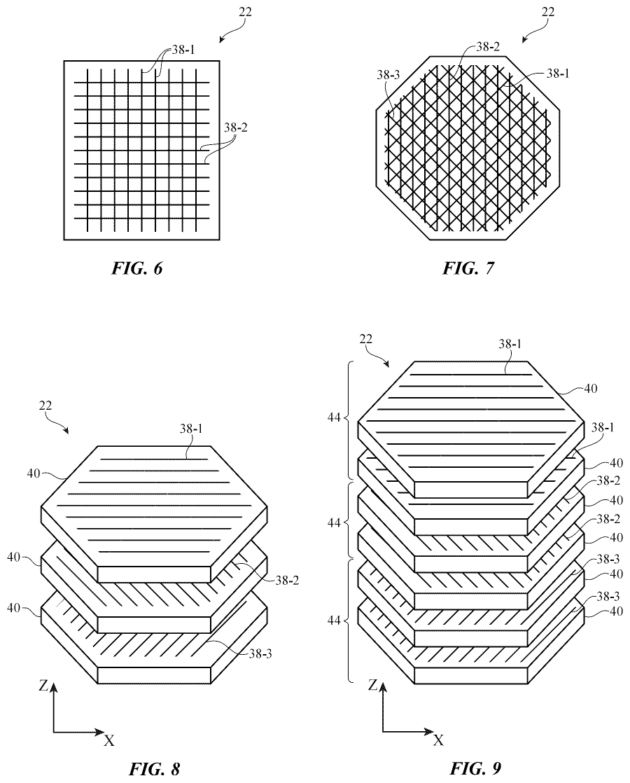

FIG. 6 is a top view of an illustrative adjustable lens component 22 having first finger electrodes 38-1 oriented along a first direction and second finger electrodes 38-2 oriented along a second direction different from the first direction. First finger electrodes 38-1 may, for example, be oriented at 90-degree angles relative to second finger electrodes 38-2, or other suitable orientations may be used. Each set of electrodes may modulate the phase profile of a respective liquid crystal layer along an associated dimension. Adjustable lens component 22 of the type shown in FIG. 6 with two orientations of electrodes may therefore be used to create phase profiles that vary along two dimensions. For example, electrodes 38-1 may produce a first quadratic phase profile along a first dimension and electrodes 38-2 may produce a second quadratic phase profile along a second dimension, thus providing lens components 22 with a combined phase profile matching that of a crossed-cylinder lens, with a spherical profile where the cylinders overlap (as an example).

FIG. 7 is a top view of an illustrative adjustable lens component 22 having first finger electrodes 38-1 oriented along a first direction, second finger electrodes 38-2 oriented along a second direction, and third finger electrodes 38-3 oriented along a third direction. Finger electrodes 38-1, 38-2, and 38-3 may, for example, be separated by 60-degree angles or may have other suitable orientations. Each set of electrodes may modulate the phase profile of a respective liquid crystal layer along an associated dimension. Adjustable lens components 22 of the type shown in FIG. 7 with three orientations of electrodes may therefore be used to create phase profiles that vary along three dimensions.

The examples of FIGS. 6 and 7 in which lens component 22 includes two and three orientations of electrodes, respectively, are merely illustrative. If desired, lens component 22 may include one, two, three, four, five, six, more than six, or any other suitable number of orientations of electrodes to enable lens component 22 to achieve different phase profiles across any suitable number of dimensions. Lens components 22 with multiple orientations of electrodes may be configured to simultaneously correct for optical aberrations such as defocus, astigmatism, coma, trefoil, spherical, and/or other aberrations. Arrangements in which adjustable lens components 22 include three orientations of electrodes are sometimes described herein as an illustrative example.

FIGS. 8 and 9 show exploded perspective views of illustrative lens components 22 with three orientations of electrodes. In the example of FIG. 8, adjustable lens components 22 include three liquid crystal cells 40. Each liquid crystal cell 40 may have a structure of the type described in connection with FIG. 2, with finger electrodes 38-1, 38-2, and 38-3 oriented along three different directions. For example, finger electrodes 38-1 may be oriented at 0 degrees relative to the X-axis, finger electrodes 38-2 may be oriented at 120 degrees relative to the X-axis, and finger electrodes 38-3 may be oriented at 60 degrees relative to the X-axis. This is merely illustrative, however. In general, electrodes 38-1, 38-2, and 38-3 may have any suitable orientation.

In the example of FIG. 9, adjustable lens components 22 include three liquid crystal modules 44. Each liquid crystal module 44 may have a structure of the type described in connection with FIG. 3. In particular, each liquid crystal module 44 may include an upper liquid crystal cell 40 and a lower liquid crystal cell 40. The liquid crystal layers of the upper and lower liquid crystal cells 40 may, if desired, have antiparallel liquid crystal alignment orientations. As shown in FIG. 9, finger electrodes 38-1, 38-2, and 38-3 of liquid crystal modules 44 are oriented along three different directions. For example, finger electrodes 38-1 may be oriented at 0 degrees relative to the X-axis, finger electrodes 38-2 may be oriented at 120 degrees relative to the X-axis, and finger electrodes 38-3 may be oriented at 60 degrees relative to the X-axis. This is merely illustrative, however. In general, electrodes 38-1, 38-2, and 38-3 may have any suitable orientation.

The foregoing examples in which lens components 22 have a rectangular shape (FIG. 6) or a hexagonal shape (FIGS. 7, 8, and 9) are merely illustrative. If desired, lens component 22 (e.g., substrate 30, substrate 32, liquid crystal layer 34, etc.) may have circular shapes, triangular shapes, pentagonal shapes, oval shapes, ergonomic shapes, convex shapes, or any other suitable shape. Arrangements in which lens components 22 are hexagonal are sometimes described herein as an illustrative example.

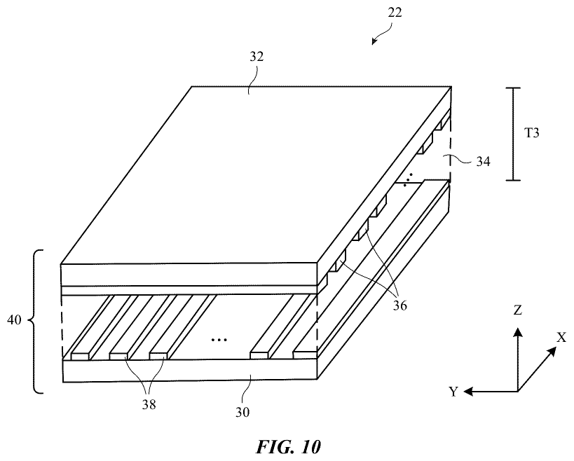

In some arrangements, both the upper and lower arrays of electrodes in cell 40 may include strip-shaped finger electrodes, forming a grid of orthogonal (or otherwise non-parallel) conductive lines that can be driven at different voltages using a passive matrix addressing scheme. This type of arrangement is illustrated in FIG. 10.

As shown in the example of FIG. 10, finger electrodes 38 may extend along the X dimension on substrate 30, and finger electrodes 36 may extend along the Y dimension on substrate 32. If desired, finger electrodes 38 may extend along the Y dimension on substrate 30, and finger electrodes 36 may extend along the X dimension on substrate 32. The example of FIG. 10 is merely illustrative. Electrodes 36 and 38 may be formed from transparent conductive material such as indium tin oxide, conductive polymers such as poly(3,4-ethylenedioxythiophene) polystyrene sulfonate (PEDOT:PPS), silver nanowires, or other transparent electrode structures and may be located on outer and/or inner surfaces of substrates 32 and 30.

In the example of FIG. 10, electrodes 38 and 36 are oriented at 90 degrees relative to one another. This is merely illustrative. In general, electrodes 38 and 36 may be separated by 60 degrees, 80 degrees, 110 degrees, 130 degrees, 160 degrees, and/or any other suitable angle between 0 degrees and 180 degrees. Arrangements in which electrodes 38 and 36 are orthogonal to one another are sometimes described herein as an illustrative example.

In a passive matrix driving scheme where electrodes 38 and electrodes 36 are patterned finger electrodes extending in two orthogonal (or otherwise non-parallel) directions, control circuitry 26 may be configured to control the phase profile of liquid crystal layer 34 along two dimensions. The voltage at each liquid crystal “pixel” where a given upper electrode 36 overlaps a given lower electrode 38 may be equal to the difference between the voltage applied to that upper electrode 36 and the voltage applied to that lower electrode 38. By controlling the voltages on electrodes 36 and electrodes 38, the index of refraction of liquid crystal layer 34 of component 22 can be dynamically adjusted across two different directions (e.g., the X and Y dimensions of FIG. 10) to produce customized lenses.

When an electric field is applied to the liquid crystals of layer 34, the liquid crystals change orientation. The speed at which a given liquid crystal material can be reoriented is limited by factors such as the thickness of layer 34 (e.g., thickness T3 of FIG. 10, sometimes referred to as the cell gap). To increase the tuning speed of liquid crystal layer 34 while still achieving a suitable tuning range, adjustable lens component 22 may include two or more liquid crystal cells 40 stacked on top of one another, as shown in the example of FIG. 3 (e.g., in which liquid crystal layer 34 of each liquid crystal cell 40 has a thickness T2 less than T3).

Some types of liquid crystal modulate only light of one polarization, leaving light of the other polarization (for example, the polarization direction orthogonal to the rubbing direction in an electrically controlled birefringence cell) largely unmodulated. If desired, additional layers with different rubbing directions (e.g. with rubbing directions at ninety degree angles to each other) can be employed so that both polarizations can be modulated by adjustable lens component 22. Alternatively, a polarizing filter that removes light of the unmodulated polarization can be added to the module.

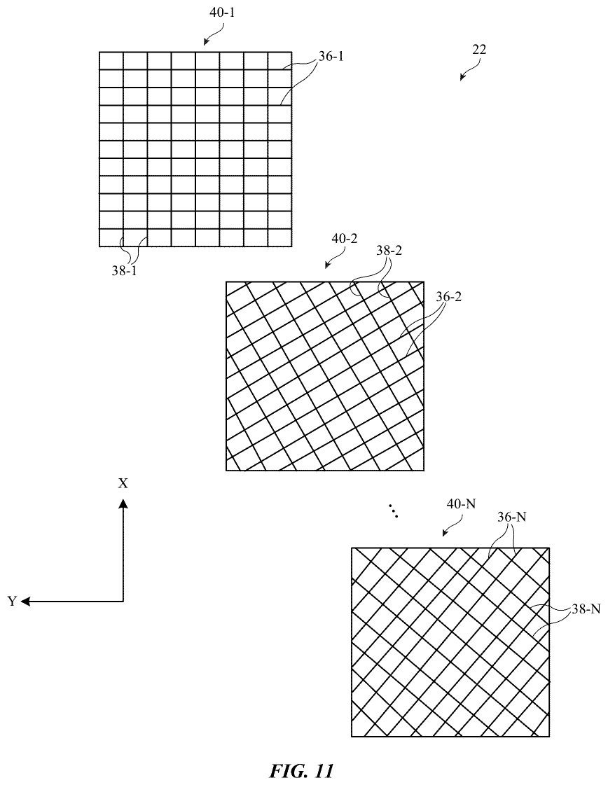

Due to the nonlinearity of liquid crystal material, a single liquid crystal cell that is driven with a passive matrix addressing scheme may exhibit unwanted aberrations. Such aberrations can be mitigated or eliminated by stacking multiple liquid crystal cells with passive matrix electrode arrays oriented in different directions so that unwanted aberrations can be compensated for by applying appropriate voltages to the different liquid crystal cells. This type of arrangement is illustrated in FIG. 11.

As shown in FIG. 11, adjustable lens 22 may include N liquid crystal cells such as liquid crystal cell 40-1, liquid crystal cell 40-2, etc., up to liquid crystal cell 40-N. There may be any suitable number of stacked liquid crystal cells 40 in lens 22 (e.g., two, three, four, five, six, seven, eight, nine, ten, eleven, twelve, more than twelve, less than twelve, etc.).

Liquid crystal cell 40-1 may have a pair of electrode arrays such as finger electrodes 38-1 oriented along a first direction and finger electrodes 36-1 oriented along a second direction orthogonal (or otherwise non-parallel) to the first direction. Finger electrodes 38-1 may, for example, extend parallel to the X-axis of FIG. 11, whereas finger electrodes 36-1 may extend parallel to the Y-axis of FIG. 11. Electrodes 36-1 and 38-1 may modulate the phase profile of liquid crystal layer 34 in cell 40-1 along first and second dimensions.

Liquid crystal cell 40-2 may have an additional pair of electrode arrays such as finger electrodes 38-2 and finger electrodes 36-2 that are configured to modulate the phase profile of liquid crystal layer 34 in cell 40-2 along two orthogonal (or otherwise non-parallel) dimensions. Electrodes 38-2 and 36-2 may be rotated relative to the electrodes in other liquid crystal cells in the stack. For example, finger electrodes 38-2 may be rotated by a given amount relative to finger electrodes 38-1, and finger electrodes 36-2 may be rotated by the same amount relative to finger electrodes 36-1.

Liquid crystal cell 40-N may have an additional pair of electrode arrays such as finger electrodes 38-N and finger electrodes 36-N that are configured to modulate the phase profile of a liquid crystal layer 34 in cell 40-N along two orthogonal (or otherwise non-parallel) dimensions. Electrodes 38-N and 36-N may be rotated relative to the electrodes in other liquid crystal cells in the stack. For example, finger electrodes 38-N may be rotated by a given amount relative to finger electrodes 38-1, and finger electrodes 36-N may be rotated by the same amount relative to finger electrodes 36-1.

The amount of rotation between one set of electrodes and another set of electrodes in lens 22 may, if desired, be based on the total number of liquid crystal cells in lens 22. For example, in arrangements where lens 22 includes six stacked liquid crystal cells, each electrode pair may be rotated relative to another electrode pair by 15 degrees, if desired. In other words, electrodes 38-1 and 36-1 in cell 40-1 would be oriented at zero degrees relative to the X and Y axes of FIG. 11, respectively; electrodes 38-2 and 36-2 in cell 40-2 would be oriented at 15 degrees relative to the X and Y axes of FIG. 11, respectively; electrodes 38 and 36 in a third cell 40 would be oriented at 30 degrees relative to the X and Y axes of FIG. 11, respectively; electrodes 38 and 36 in a fourth cell 40 would be oriented at 45 degrees relative to the X and Y axes of FIG. 11, respectively; electrodes 38 and 36 in a fifth cell 40 would be oriented at 60 degrees relative to the X and Y axes of FIG. 11, respectively; and electrodes 38 and 36 in the sixth cell 40 would be oriented at 75 degrees relative to the X and Y axes of FIG. 11, respectively.

This is, however, merely illustrative. There may be any suitable number of stacked liquid crystal cells in lens 22 with any suitable amount of rotation between electrode orientations (e.g., eight cells 40 with 11.25 degrees of rotation between electrode orientations, ten cells 40 with 9 degrees of rotation between electrode orientations, four cells 40 with 22.5 degrees of rotation between electrode orientations, twelve cells 40 with 7.5 degrees of rotation between electrode orientations, etc.).

The use of equal angular spacing between electrode arrays is merely illustrative. In some applications, such as when a specific orientation (or several orientations) of astigmatism (or other non-rotationally-symmetric aberration) can be anticipated at the time of designing lens 22, it may be desirable to implement an uneven angular spacing between electrode orientations that permit better performance at that specific orientation or orientations where the astigmatism can be anticipated. For example, the astigmatism of certain progressive power ophthalmic lenses can have a predominant orientation. In that case, an uneven distribution of orientations of electrodes 38-1, 38-2, . . . 38-N that accounts for the known orientation of the astigmatism may be used, if desired.

In the example of FIG. 11, each liquid crystal cell 40 is shown having first and second electrode arrays oriented at 90 degrees relative to one another. This is merely illustrative. If desired, the first and second electrode arrays in each liquid crystal cell 40 may be oriented at any other suitable angle (e.g., 60 degrees, 80 degrees, 110 degrees, 130 degrees, 160 degrees, etc.) relative to one another.

Arrangements in which at least two of liquid crystal cells 40 in lens 22 have different angles between their respective first and second electrode arrays may also be used. For example, liquid crystal cell 40-1 may have first and second electrode arrays oriented at 90 degrees relative to one another, whereas liquid crystal cell 40-2 may have first and second electrode arrays oriented at 80 degrees relative to one another. In this type of scenario, the amount of rotation between electrodes 36-1 of cell 40-1 and electrodes 36-2 of cell 40-2 may be different than the amount of rotation between electrodes 38-1 of cell 40-1 and electrodes 38-2 of cell 40-2. For example, electrodes 36-1 of cell 40-1 may be rotated relative to electrodes 36-2 of cell 40-2 by some nonzero amount, whereas electrodes 38-1 of cell 40-1 may be parallel to electrodes 38-2 of cell 40-2 (or may otherwise be rotated relative to electrodes 38-2 by an angle different from the angle between electrodes 36-1 and 36-2).

Lens components 22 with multiple orientations of electrodes may be configured to correct for optical aberrations such as progressive or static myopia, hyperopia, presbyopia, defocus, astigmatism, coma, trefoil, spherical, and/or other aberrations that may be fixed or accommodation-dependent. Arrangements in which adjustable lens components 22 include six orientations of electrodes are sometimes described herein as an illustrative example.

Liquid crystal cells 40 having a parallel or antiparallel rubbing direction modulate normally incident light of one linear polarization. When a user is viewing unpolarized content, it may be desirable to include a second set cells 40 with an orthogonal rubbing direction relative to the first set of cells 40 in lenses 22. For example, each lens 22 may include two sets of the liquid crystal cells 40 shown in FIG. 11. The second set of cells 40 may have the same set of orientations of electrodes as the first set of cells 40 or may have a distinct set of orientations.

In some arrangements, control circuitry 26 may modulate the lens power across the entirety of each lens component 22. This type of arrangement may be useful in configurations where glasses 14 do not include sensor system 24 for eye tracking and/or when the tuning speed of lens components 22 is not sufficiently high to maintain focus when the user's eye moves. Modulating the lens power from edge to edge of components 22 may ensure that the image remains in focus even when the user's eye moves around.

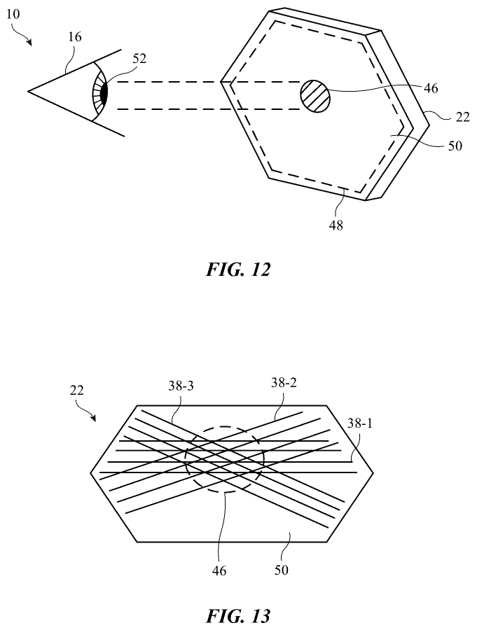

In other arrangements, control circuitry 26 may modulate lens power across only a portion of lens component 22. This type of foveated lens arrangement is illustrated in FIG. 12.

Viewers are most sensitive to image detail in the main field of view. Peripheral regions of a lens may therefore be provided with a different phase profile than the region of the lens within the user's gaze. The peripheral regions of the lens that are outside of the viewer's gaze may, for example, be optically unmodulated, may be provided with a phase profile that is constant across a given area, and/or may be provided with a phase profile that is less spatially varied than the portion of the lens in the direction of the viewer's gaze. The regions of the lens outside of the user's gaze may have an optical power magnitude that is less than the optical power magnitude of the lens region within the user's gaze. By including lower power areas in a variable-power lens, total required variable phase depth and power consumption can be minimized and/or reduced. Further, magnification changes (which could be disorienting to the user) are experienced only over the area of the lens where focal power is modulated. Gaze detection data (e.g., gathered using sensor system 24) may be used in determining which portion of lens component 22 is being directly viewed by viewer 16 and should therefore have the optically appropriate prescription and which portions of lens components 22 are in the viewer's peripheral vision and could be left optically unmodulated or otherwise provided with a phase profile having less spatial variation than the portions of lens components 22 within the viewer's gaze.

As shown in FIG. 12, for example, adjustable lens component 22 may have an active area such as active area 48. Within active area 48, adjustable lens components 22 may include one or more materials having an electrically adjustable index of refraction (e.g., liquid crystal cells 40 of the type discussed in connection with FIGS. 1-11). Control circuitry 26 may dynamically adjust the phase profile of lens components 22. Active area 48 may include gaze area 46 and peripheral area 50. Gaze area 46 corresponds to the portions of lens components 22 that are within the user's gaze, whereas peripheral area 50 corresponds to the portions of lens components 22 that are outside of the user's gaze (e.g., portions of lens components 22 that are in the user's peripheral vision). Gaze area 46 of lens components 22 may be provided with a different phase profile than peripheral area 50. For example, gaze area 46 may be optically modulated to produce a first lens power, while peripheral area 50 may be left optically unmodulated, may be optically modulated to produce a second lens power magnitude that is less than the first lens power magnitude, and/or may be optically modulated to produce a phase profile that is less spatially varied than the phase profile of gaze area 46.

Control circuitry 26 may dynamically adjust the location, size, resolution, or shape of gaze area 46 and peripheral area 50 during operation of glasses 14. For example, control circuitry 26 may use sensor system 24 to track a user's gaze and may adjust the location of gaze area 46 so that it remains aligned with the user's gaze. If desired, the size of gaze area 46 may be based on the size of the foveal region in a user's eyes, the user's pupil diameter, and/or the desired phase profile for gaze area 46. Gaze area 46 may, for example, have a diameter between 4 mm and 9 mm, between 7 mm and 9 mm, between 6 mm and 10 mm, between 4 mm and 8 mm, between 8 mm and 12 mm, greater than 10 mm, less than 10 mm, or any other suitable size. The size of gaze area 46 may be based on a distance between lens components 22 and a user's eyes 16, may be based on the size of the user's pupil 52 (e.g., as measured with sensor system 24 or as inferred based on eye charts, ambient light levels, or other data), and/or may be based on other information.

In gaze area 46, control circuitry 26 may modulate the index of refraction of liquid crystal material 34 to obtain the desired lens power and the desired vision correction properties for the viewer. This may include, for example, controlling each finger electrode 38 independently or controlling small sets of finger electrodes 38 with common control signals. In peripheral area 50, control circuitry 26 may control larger sets of finger electrodes 38 with common control signals and/or may provide a ground or baseline voltage to finger electrodes 38 (e.g., may deactivate some finger electrodes 38). If desired, optical power may be constant across gaze area 46 and phase may be flat across peripheral area 50. In other suitable arrangements, optical power may be varied across gaze area 46 and/or peripheral area 50.

FIG. 13 is a top view of illustrative adjustable lens components 22 showing how areas of different optical power magnitude may be achieved. As shown in FIG. 13, adjustable lens components 22 may include gaze area 46 and peripheral area 50. Gaze area 46 may have a first lens power magnitude and peripheral area 46 may have a second lens power magnitude that is less than the first lens power magnitude. Gaze area 46 may, for example, align with the foveal region of a user's eyes 16 (as shown in FIG. 12). Electrodes that overlap (i.e., pass through) gaze area 46 such as electrodes 38-1, 38-2, and 38-3 may be controlled to make a desired prescription within gaze area 46 and electrodes that do not pass through gaze area 46 (not shown in FIG. 13) may be controlled to produce a spatially constant phase or a phase that otherwise has less spatial variation than that of gaze area 46.

Control circuitry 26 may dynamically adjust the location of gaze area 46 based on gaze location information from sensor system 24 by actively identifying which electrodes are within a user's gaze and which electrodes are outside of a user's gaze. Electrodes within a user's gaze (e.g., in area 46) may be operated in optically modulated mode, and electrodes outside of the user's gaze (e.g., in area 50) may be operated in constant phase mode or may otherwise be operated to produce a phase profile with less spatial variation than that of gaze area 46.

Whereas lens components with only two different electrode orientations may be capable of expressing spherical profiles and correcting one of two modes of astigmatism, lens components with three or more electrode orientations may be capable of expressing a greater number of different types of phase profiles (to correct higher order aberrations, astigmatism with any rotational axis, coma, spherical aberration, etc.). Additionally, using more than two electrode orientations may help ease the transition between gaze region 46 (e.g., where the phase profile of liquid crystal layer 34 is actively controlled) and peripheral region 50 (e.g., where the phase profile of liquid crystal layer 34 is not actively controlled).

In arrangements where adjustable lens component 22 includes multiple liquid crystal cells 40, it can be challenging to route signals to all of the liquid crystal cells 40 in the stack (e.g., to electrodes 38 and 36 of each liquid crystal cell 40). There may be many control signal lines for each liquid crystal cell 40. For example, each liquid crystal cell 40 may include 100 to 200 control signal lines, 200 to 300 control lines, 300 to 400 control lines, more than 400 control lines, less than 40 control lines, or other suitable number of control lines. When combined with other liquid crystal cells 40, there may be thousands (e.g., more than 3000, more than 4000, less than 4000, or other suitable number) of control lines in a single adjustable lens component 22, which may only be a few centimeters wide (e.g., 3 cm to 4 cm wide, 2 cm to 5 cm wide, more than 5 cm wide, less than 5 cm wide, etc.).

If desired, multiple flex circuits may be respectively coupled to each substrate in the stack such as substrates 30 and 32, or a single flex circuit may be coupled to one of substrates 30 and 32 and conductive beads in a sealant that surrounds liquid crystal material 34 may be used to carry signals between substrates 30 and 32. In some arrangements, fewer flex circuits may be used by forming interconnections between liquid crystal cells 40 using through-substrate-vias, conductive beads in the liquid crystal sealant, and/or additional conductive materials such as anisotropic conductive adhesive, conductive epoxy, solder, and/or other conductive materials. If desired, techniques such as thermocompression and/or thermosonic bonding may be used to form cell-to-cell connections in lens 22.

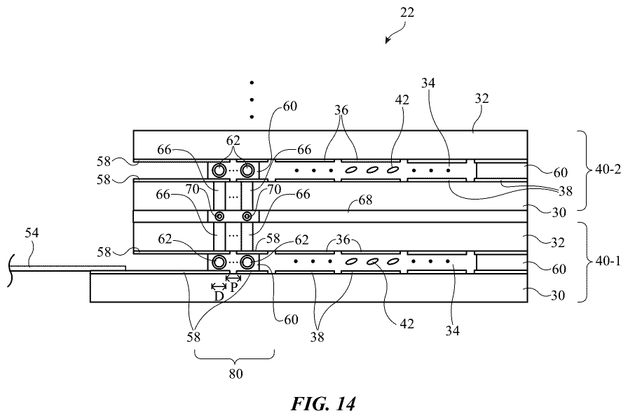

FIG. 14 is a side view of an illustrative adjustable lens 22 that includes a stack of liquid crystal cells 40 such as liquid crystal cell 40-1 and liquid crystal cell 40-2. If desired, lens 22 may include a stack of three liquid crystal cells 40, four liquid crystal cells 40, five liquid crystal cells 40, six liquid crystal cells 40, seven liquid crystal cells 40, eight liquid crystal cells 40, or more than eight liquid crystal cells 40. As shown in FIG. 14, a printed circuit such as printed circuit 54 (e.g., a flexible printed circuit substrate) may be coupled to a single liquid crystal cell in the stack such as liquid crystal cell 40-1. Signals may be routed from flex circuit 54 to the remaining liquid crystal cells 40 in lens 22 using interconnections such as vertical interconnections 80. There may be hundreds of vertical interconnections 80 passing through the stack of liquid crystal cells 40 that form lens components 22, if desired. Each vertical interconnection 80 may be used to convey signals to a single electrode (e.g., one of electrodes 36 or one of electrodes 38), or each vertical interconnection 80 may be used to convey signals to a group of electrodes (e.g., a group of electrodes 36 and/or a group of electrodes 38). If desired, some of vertical interconnections 80 may be redundant to ensure that signals can be routed to electrodes 36 and 38 even if one of vertical interconnections 80 is compromised.

The use of a single flex circuit 54 to provide signals to all of liquid crystal cells 40 in lens 22 is merely illustrative. If desired, more than one flex circuit 54 may be used to provide signals to liquid crystal cells 40 (e.g., lens 22 may have one flex circuit 54 per liquid crystal cell 40, may have two flex circuits on cell 40-1 that provide signals to the remaining cells 40 in lens 22, etc.). Each flex circuit 54 may carry a different portion of the signals that need to be provided to the stack of cells 40, or each flex circuit 54 may carry a replica of all of the signals that need to be provided to the stack of cells 40 so that if there is a break in a given vertical interconnection 80, signals can be provided using a different flex 54.

Vertical interconnections 80 may include intra-cell connections that convey signals between substrates 30 and 32 of each liquid crystal cell 40. In the example of FIG. 14, intra-cell connections are formed from conductive beads in a sealant. As shown in FIG. 14, liquid crystal material 34 may be surrounded by a sealant such as sealant 60. Sealant 60 may be configured to contain liquid crystal material 34 within a given volume between substrates 30 and 32. Sealant 60 may form a ring (e.g., a loop) around liquid crystal material 34. Sealant 60 may contain conductive beads such as conductive beads 62. Conductive beads 62 (sometimes referred to as conductive balls) may be insulated from one another so that each conductive bead 62 can carry a signal independently from adjacent conductive beads 62. If desired, the pitch P between conductive beads 62 may be at least two times the diameter D of each conductive bead 62 to ensure that conductive beads 62 that are carrying different signals are not inadvertently shorted together. This is merely illustrative. If desired, conductive beads 62 may have other suitable pitch values.

The example of FIG. 14 in which sealant 60 forms a liquid crystal sealant that surrounds liquid crystal material 34 is merely illustrative. If desired, lens 22 may have a dedicated liquid crystal sealant for containing liquid crystal material 34 (e.g., a first sealant without conductive beads) and sealant 60 may be a separate (e.g., second) sealant that fully or partially surrounds the liquid crystal sealant.

Each conductive bead 62 may be electrically coupled to first and second respective contacts 58 on substrates 30 and 32. In particular, a first side of bead 62 may be electrically connected to contact 58 on substrate 30 and a second opposing side of bead 62 may electrically connected to contact 58 on substrate 32. Liquid crystal cell 40-1, liquid crystal cell 40-2, and any other liquid crystal cells 40 in lens 22 may each have sealant 60 with conductive beads 62 surrounding liquid crystal material 34. In this way, signals from flex circuit 54 may be routed between substrates 30 and 32 of each liquid crystal cell 40.

Vertical interconnections 80 may also include inter-cell connections that are used to convey signals between cells 40 (e.g., between liquid crystal cell 40-1 and liquid crystal cell 40-2, and between other liquid crystal cells 40 in lens 22). In the example of FIG. 14, inter-cell connections are formed using through-substrate-vias such as through-substrate-vias 66 and conductive material between the vias such as anisotropic conductive adhesive 68. Through-substrate-vias 66 may include through-glass-vias (e.g., when substrates 30 and 32 are glass substrates) or through-plastic-vias (e.g., when substrates 30 and 32 are plastic substrates). Vias 66 may be filled vias that are filled with conductive material (e.g., aluminum, copper, or other metal material), or vias 66 may be lined vias that are lined with conductive material such as metal. Anisotropic conductive adhesive 68 may include conductive particles such as conductive particles 70. Groups of conductive particles 70 may be electrically insulated from one another and may be used to form independent signal paths between vias 66.

Each via 66 may pass entirely through a given one of substrates 30 and 32. For example, a first set of vias 66 may pass through substrate 32 of liquid crystal cell 40-1. Each via 66 in substrate 32 may have a first end coupled to a respective contact 58 on a first side of substrate 32 and an opposing second end coupled to a respective group of conductive particles 70 of anisotropic adhesive layer 68 on the opposing second side of substrate 32. A second set of vias 66 may pass through substrate 30 of liquid crystal cell 40-2. Each via 66 in substrate 30 may have a first end coupled to a respective contact 58 on a first side of substrate 30 and an opposing second end coupled to a respective group of conductive particles 70 of anisotropic adhesive layer 68 on the opposing second side of substrate 30. In this way, signals may be routed from flex circuit 54 to some or all of liquid crystal cells 40 in lens 22 using vertical interconnections 80.

For example, signals on a given signal path may be conveyed from flex circuit 54 to a respective contact 58 on substrate 30 of liquid crystal cell 40-1, to a respective conductive bead 62 in sealant 60 of liquid crystal cell 40-1, to a respective contact 58 on substrate 32 of liquid crystal cell 40-1, to a respective through-substrate-via 66 in substrate 32, to a respective group of conductive particles 70 in anisotropic adhesive layer 68, to a respective through-substrate-via 66 in substrate 30 of liquid crystal cell 40-2, to a respective contact 58 on substrate 30 of liquid crystal cell 40-2, to a respective conductive bead 62 in sealant 60 of liquid crystal cell 40-2, to a respective contact 58 on substrate 32 of liquid crystal cell 40-2. Electrodes 38 on substrate 30 of each liquid crystal cell 40 may receive voltages from contacts 58 on substrate 30 of that liquid crystal cell 40, whereas electrodes 36 on substrate 32 of each liquid crystal cell 40 may receive voltages from contacts 58 on substrate 32 of that liquid crystal cell. If desired, vertical interconnections 80 may be repeated for additional liquid crystal cells 40 in the stack of cells that forms lens 22.

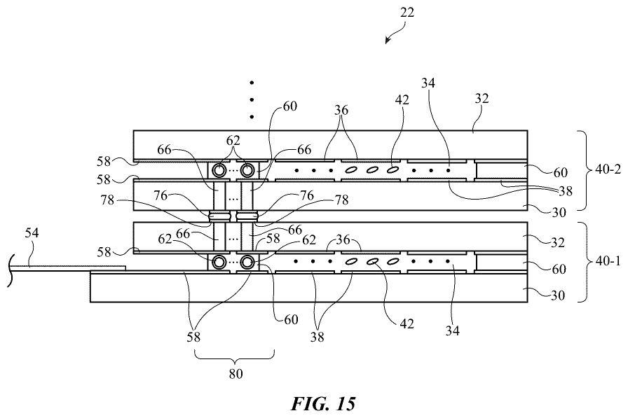

The use of anisotropic conductive adhesive to form inter-cell connections in lens 22 is merely illustrative. If desired, anisotropic conductive adhesive layer 68 may be replaced by a different type of conductive material, as shown in FIG. 15. In the example of FIG. 15, inter-cell connections between liquid crystal cells 40-1 and 40-2 include conductive material 76 and contacts 78. Conductive material 76 may be conductive epoxy (e.g., Indium epoxy), solder, diffusion bonding material (e.g., an aluminum-to-aluminum diffusion bond), eutectic bonding material (e.g., an aluminum-to-solder eutectic bond), and/or other suitable conductive material. If desired, thermocompression techniques (e.g., applying heat and pressure) or thermosonic bonding techniques (e.g., applying ultrasonic energy and pressure) may be used to form via-to-via bonds using conductive material 76 between vias 66. In some arrangements, the same material may be used to form vias 66 and contacts 78 (e.g., in a single step), and the same material may be used to form vias 66 and contacts 58 (e.g., in separate steps). Electrodes 38 on substrate 30 of each liquid crystal cell 40 may receive voltages from contacts 58 on substrate 30 of that liquid crystal cell 40, whereas electrodes 36 on substrate 32 of each liquid crystal cell 40 may receive voltages from contacts 58 on substrate 32 of that liquid crystal cell. If desired, vertical interconnections 80 may be repeated for additional liquid crystal cells 40 in the stack of cells that forms lens 22.

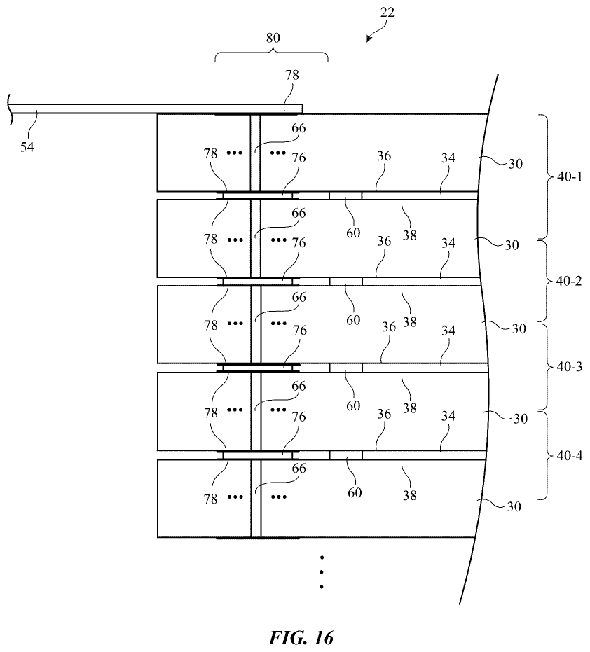

If desired, some of liquid crystal cells 40 in lens 22 may have substrates that are shared with other liquid crystal cells 40 in lens 22 to reduce the number of interconnects needed between liquid crystal cells 40. This type of arrangement is illustrated in FIG. 16.

As shown in FIG. 16, lens 22 may include multiple liquid crystal cells 40 such as liquid crystal cell 40-1, liquid crystal cell 40-2, liquid crystal cell 40-3, and liquid crystal cell 40-4. Each liquid crystal cell 40 may include a layer of liquid crystal material 34 sandwiched between substrates such as substrates 30. Some of substrates 30 may be shared by two liquid crystal cells 40. For example, liquid crystal cell 40-1 may have an upper substrate 30 and a lower substrate 30. The lower substrate 30 may form an upper substrate of liquid crystal cell 40-2. In particular, electrodes 38 of liquid crystal cell 40-1 may be formed on a first side of that lower substrate 30, and electrodes 36 of liquid crystal cell 40-2 may be formed on an opposing second side of that same lower substrate 30. Aside from the two outermost substrates 30, each substrate 30 may have an upper surface with electrodes 38 of one liquid crystal cell 40 and an opposing lower surface with electrodes 36 of a different liquid crystal cell 40. In this way, only five substrates 30 are needed to form four liquid crystal cells 40 (e.g., instead of using eight substrates to form four liquid crystal cells 40).

Since lens 22 of FIG. 16 uses shared substrates 30 for adjacent liquid crystal cells 40, intra-cell connections may also form inter-cell connections, thus reducing the number of conductive structures that are needed to form vertical interconnections 80. In the example of FIG. 16, vertical interconnections 80 are formed using through-substrate-vias 66, conductive material 76, and contacts 78. Each via 66 may pass through a respective one of substrates 30 and may have a first end coupled to contact 78 on a first side of that substrate 30 and an opposing second end coupled to contact 78 on an opposing second side of that substrate 30. Conductive material 76 may be conductive epoxy (e.g., Indium epoxy), solder, diffusion bonding material (e.g., an aluminum-to-aluminum diffusion bond), eutectic bonding material (e.g., an aluminum-to-solder eutectic bond), and/or other suitable conductive material that forms via-to-via connections between substrates 30. If desired, thermocompression techniques (e.g., applying heat and pressure) or thermosonic bonding techniques (e.g., applying ultrasonic energy and pressure) may be used to form via-to-via bonds using conductive material 76 between vias 66.

Electrodes 38 on substrate 30 of each liquid crystal cell 40 may receive voltages from contacts 78 on an upper substrate 30 of that liquid crystal cell 40, and electrodes 36 on lower substrate 30 of each liquid crystal cell 40 may receive voltages from contacts 78 on lower substrate 30 of that liquid crystal cell 40. If desired, vertical interconnections 80 may be repeated for additional liquid crystal cells 40 in the stack of cells that forms lens 22.

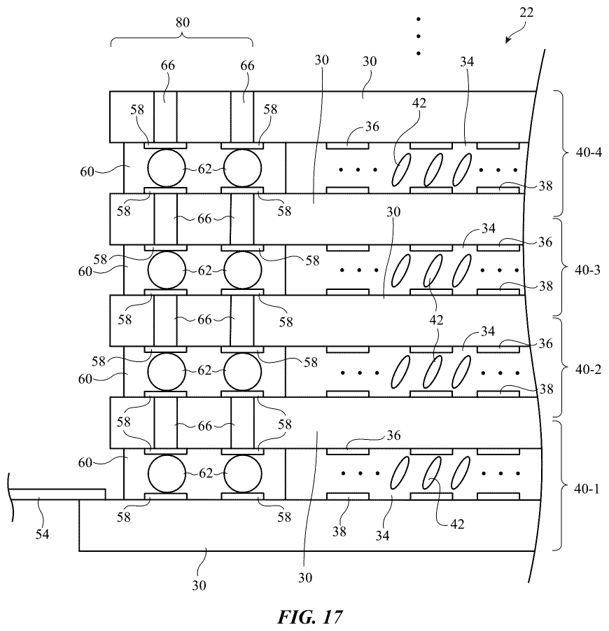

The example of FIG. 16 in which intra-cell connections (and thus inter-cell connections) are formed using conductive material 76 between vias 66 is merely illustrative. If desired, conductive material 76 may be replaced by an anisotropic conductive adhesive layer such as anisotropic conducive adhesive 68 of FIG. 14. In another arrangement, intra-cell connections (and inter-cell connections) may be formed using conductive beads in the liquid crystal sealant. This type of arrangement is illustrated in FIG. 17.

As shown in FIG. 17, lens 22 may include multiple liquid crystal cells 40 such as liquid crystal cell 40-1, liquid crystal cell 40-2, liquid crystal cell 40-3, and liquid crystal cell 40-4. Each liquid crystal cell 40 may include a layer of liquid crystal material 34 sandwiched between substrates such as substrates 30. Some of substrates 30 may be shared by two liquid crystal cells 40. For example, liquid crystal cell 40-1 may have an upper substrate 30 and a lower substrate 30. The lower substrate 30 may form an upper substrate of liquid crystal cell 40-2. In particular, electrodes 38 of liquid crystal cell 40-1 may be formed on a first side of that lower substrate 30, and electrodes 36 of liquid crystal cell 40-2 may be formed on an opposing second side of that same lower substrate 30. Aside from the two outermost substrates 30, each substrate 30 may have an upper surface with electrodes 38 of one liquid crystal cell 40 and an opposing lower surface with electrodes 36 of a different liquid crystal cell 40. In this way, only five substrates 30 are needed to form four liquid crystal cells 40 (e.g., instead of using eight substrates to form four liquid crystal cells 40).

Since lens 22 of FIG. 17 uses shared substrates 30 for adjacent liquid crystal cells 40, intra-cell connections may also form inter-cell connections, thus reducing the number of conductive structures that are needed to form vertical interconnections 80. In the example of FIG. 17, vertical interconnections 80 are formed using through-substrate-vias 66 and conductive beads 62 in sealant 60 that form via-to-via connections between substrates 30. Each via 66 may pass through a respective one of substrates 30 and may have a first end coupled to (e.g., through contact 58) one or more respective beads 62 in sealant 60 of one liquid crystal cell 40 and an opposing second end coupled to (e.g., through contact 58) one or more respective beads 62 in sealant 60 of a different liquid crystal cell 40.

Electrodes 38 on substrate 30 of each liquid crystal cell 40 may receive voltages from contacts 58 on an upper substrate 30 of that liquid crystal cell 40, and electrodes 36 on lower substrate 30 of each liquid crystal cell 40 may receive voltages from contacts 58 on lower substrate 30 of that liquid crystal cell 40. If desired, vertical interconnections 80 may be repeated for additional liquid crystal cells 40 in the stack of cells that forms lens 22.

Some of the figures include cross-sectional side views and may or may not include oblique hatching. The oblique hatching in a cross-sectional diagram may omitted in some instances to avoid impeding a clear reading of the reference signs and leading lines.

The foregoing is merely illustrative and various modifications can be made to the described embodiments. The foregoing embodiments may be implemented individually or in any combination.

What is claimed is:

1. An adjustable lens, comprising:
first and second stacked liquid crystal cells, wherein the first liquid crystal cell comprises first liquid crystal material and first electrodes that adjust a phase profile of the first liquid crystal material and wherein the second liquid crystal cell comprises second liquid crystal material and second electrodes that adjust a phase profile of the second liquid crystal material;
a printed circuit coupled to the first liquid crystal cell; and
conductive material interposed between the first liquid crystal cell and the second liquid crystal cell, wherein the conductive material conveys electrical signals between the first liquid crystal cell and the second liquid crystal cell.

2. The adjustable lens defined in claim 1 wherein the conductive material is selected from the group consisting of: conductive epoxy, anisotropic adhesive, metal, and solder.

3. The adjustable lens defined in claim 1 wherein the first liquid crystal cell comprises first and second substrates and the second liquid crystal cell comprises third and fourth substrates.

4. The adjustable lens defined in claim 3 wherein the printed circuit is coupled to the first substrate, wherein the second substrate comprises first through-substrate-vias, and wherein the third substrate comprises second through-substrate-vias.

5. The adjustable lens defined in claim 4 wherein the first liquid crystal cell comprises first sealant around the first liquid crystal material and the second liquid crystal cell comprises second sealant around the second liquid crystal material, wherein the first sealant comprises first conductive beads electrically coupled to the first through-substrate-vias, and wherein the second sealant comprises second conductive beads electrically coupled to the second through-substrate-vias.

6. The adjustable lens defined in claim 5 wherein the conductive material is electrically coupled between the first through-substrate-vias and the second through-substrate-vias.

7. The adjustable lens defined in claim 6 wherein the first conductive beads are electrically insulated from one another and the second conductive beads are electrically insulated from one another to form independent intra-cell connections in each of the first and second liquid crystal cells.

8. The adjustable lens defined in claim 7 wherein the conductive material comprises anisotropic conductive adhesive with groups of conductive particles that are electrically insulated from one another to form independent inter-cell connections between the first and second liquid crystal cells.

9. The adjustable lens defined in claim 7 wherein the conductive material comprises via-to-via bonds that are electrically insulated from one another to form independent inter-cell connections between the first and second liquid crystal cells.

10. The adjustable lens defined in claim 1 further comprising a third liquid crystal cell interposed between the first and second liquid crystal cells, wherein the first liquid crystal cell comprises first and second substrates, wherein the third liquid crystal cell comprises a third substrate and third liquid crystal material, wherein the first liquid crystal material is sandwiched between the first and second substrates, and wherein the third liquid crystal material is sandwiched between the second and third substrates.

11. The adjustable lens defined in claim 10 wherein some of the first electrodes are located on a first surface of the second substrate and wherein the third liquid crystal cell comprises third electrodes on an opposing second surface of the second substrate.

12. The adjustable lens defined in claim 11 wherein the second substrate has first through-substrate-vias, the third substrate has second through-substrate-vias, and the conductive material forms respective via-to-via connections between the first through-substrate-vias and the second through-substrate-vias.

13. The adjustable lens defined in claim 11 wherein the second substrate has first through-substrate-vias, the third substrate has second through-substrate-vias, and the third liquid crystal material is surrounded by a sealant, and wherein the conductive material comprises conductive beads in the sealant that form respective via-to-via connections between the first through-substrate-vias and the second through-substrate-vias.

14. An adjustable lens, comprising:
first and second substrates;
liquid crystal material sandwiched between the first and second substrates;
first and second arrays of electrodes configured to adjust a phase profile of the liquid crystal material; and
sealant that surrounds the liquid crystal material, wherein the sealant comprises conductive beads that are electrically insulated from one another to form multiple independent signal paths through which signals are conveyed between the first and second substrates.

15. The adjustable lens defined in claim 14 further comprising through-substrate-vias in the second substrate that are electrically coupled to the conductive beads.

16. The adjustable lens defined in claim 15 further comprising:
third and fourth substrates stacked with the first and second substrates;
additional liquid crystal material sandwiched between the third and fourth substrates;
third and fourth arrays of electrodes configured to adjust a phase profile of the additional liquid crystal material;
a conductive material interposed between the second and third substrates; and
additional through-substrate-vias in the third substrate that are electrically coupled to the through-substrate-vias through the conductive material.

17. Eyeglasses, comprising:
a supporting frame; and
left and right adjustable lenses mounted to the supporting frame, wherein each of the left and right adjustable lenses comprises:
a stack of liquid crystal cells including first and second liquid crystal cells;
a printed circuit coupled to the first liquid crystal cell; and
interconnections that pass vertically through the stack of liquid crystal cells and that form multiple independent signal paths between the printed circuit, the first liquid crystal cell, and the second liquid crystal cell.

18. The eyeglasses defined in claim 17 wherein the interconnections comprise conductive beads in a liquid crystal sealant, through-glass-vias, and a conductive material interposed between the first and second liquid crystal cells.

19. The eyeglasses defined in claim 18 wherein each of the first and second liquid crystal cells comprises:
first and second substrates;
liquid crystal material sandwiched between the first and second substrates; and
first and second arrays of electrodes respectively located on the first and second substrates and configured to adjust a phase profile of the liquid crystal material.

20. The eyeglasses defined in claim 18 wherein the first liquid crystal cell comprises first liquid crystal material sandwiched between first and second substrates, wherein the second liquid crystal cell comprises second liquid crystal material sandwiched between the second substrate and a third substrate, wherein a first array of finger electrodes is located on a first surface of the second substrate and is configured to adjust a phase profile of the first liquid crystal material, and wherein a second array of finger electrodes is located on a second surface of the second substrate and is configured to adjust a phase profile of the second liquid crystal material.
